(19) United States
(12) Patent Application Publication
(10) Pub. No.: US 2017/0210103 A1
(43) Pub. Date: Jul. 27, 2017

(54) COLLATION SHRINK FILM PROTECTIVE STRUCTURE

(71) Applicant: E. I. DU PONT DE NEMOURS AND COMPANY, Wilmington, DE (US)

(72) Inventors: Karlheinz Hausmann, Abbesses (CH); Lucie Charbonnel, Cessy (FR); Mariane Zebri, Cruseilles (FR); Laurent Ziche, Pringy (FR)

(21) Appl. No.: 15/313,093

(22) PCT Filed: May 18, 2015
(86) PCT No.: PCT/US2015/031371

§ 371 Date: Nov. 21, 2016

Related U.S. Application Data
(60) Provisional application No. 62/000,625, filed on May 20, 2014.

(51) Int. Cl. B32B 27/08; B32B 27/32; B29C 63/00; B65D 71/00; B65D 65/40; B65B 53/02; B65B 41/12; B32B 27/30; B65D 71/08

(52) U.S. Cl. CPC B32B 27/08; B32B 27/308; B32B 27/32; B29C 63/0065; B65D 71/08; B65D 65/40; B65B 53/02; B65B 41/12; B65D 71/0088; B32B 2250/05; B32B 2250/246; B32B 2250/40; B32B 2553/00; B32B 2307/514; B32B 2307/736; B29K 2696/005

(57) ABSTRACT

Disclosed is a heat shrinkable multilayer film for pallet or multipack shrink applications comprising at least one ionomer layer comprising from 5 to 40 weight % of the film, consisting essentially of a copolymer of ethylene and methacrylic acid or acrylic acid wherein from about 1 to about 99% of the carboxylic acid groups are neutralized to carboxylate salts comprising metal ions; and at least one additional layer comprising 60 to 95 weight % of the film, comprising a polyolefin. Also disclosed are uses and methods to collation shrink the film around objects.

### FIELD OF THE INVENTION

This invention relates to a heat shrinkable film useful for collation shrink packaging.

### BACKGROUND

Many relatively small items are shipped on pallets, that is, platforms that are easily moved by forklifts or small cranes. Pallets provide convenience in loading and unloading goods from shipping containers, and in moving smaller amounts of goods over shorter distances, such as within warehouses, or to deliver a retail quantity. The small items may be unpackaged or packaged, for example in bags or boxes, when they are placed on the pallets.

A loaded pallet preferably has integrity and stability, so that the goods are not damaged or lost during shipping. To provide the necessary integrity and stability, the pallet and its load have been typically wrapped together in film, for example overlapping layers of polyethylene stretch wrap that may be applied by machine or by hand. See, e.g., U.S. Pat. No. RE 38429. Other generally practiced methods of providing integrity and stability to loaded pallets include containing the goods in a single carton or box, wrapping the pallet and its load in heat shrinkable film, and encasing the loaded pallet in a sheath or “hood” which may be heat shrinkable or stretchable. These methods are sometimes referred to, individually or collectively, as “pallet unitizing”.

Collation shrink packaging concerns the bundling of items together using heat shrinkable film. Collation shrink is used for a very wide variety of applications and notably for the secondary packaging of food or drinks. A plurality of individual items such as cans, bottles, jars or other containers which may contain food, beverages and the like may also be packed in multipacks by collation shrink packaging. For example, 2 to 6 small containers such as bottles or jars may be bundled together, or a 12- or 24-pack of bottles or cans optionally held in a cardboard base or tray, and wrapped with a heat shrinkable film which is then shrunk to a snug fit around the containers to provide convenient sales units.

The process of applying a heat shrinkable collation film includes wrapping the film around the goods, applying heat for shrinking (the film temperature during heating should be slightly below the melting point of the highest melting component but the heat of the oven can be significantly higher), removing the wrapped item from the heat shrink oven and letting it cool down. Alternatively in the case of a pallet shrink hood, the shrink hood will be opened and pulled over the pallet, subsequently heated and shrunk over the pallet. Thereafter the pallet will be removed from the oven and cooled down.

Typically, films are applied at room temperature and placed near a heat source to shrink. Suitable performance characteristics on the shrink packaging line include sufficient stiffness and retraction force allowing the film to be tightly wrapped around the items being packaged and a low enough Coefficient of Friction (COF) for machinability and package handling Films that are used in collation shrink processes require good shrinkage (high thermal shrink force) to ensure a tight fit, excellent strength after shrinkage including high tensile strength (referred to as load retention resistance), and puncture resistance to withstand handling and abuse during transportation. The film also desirably has good heat sealing to itself but does not stick to the packaged items. Desirably, the films provide excellent display properties including gloss, preferably under different angles to maximize appeal, low haze or good contact clarity and high see-through clarity. Such display properties may be important for viewing the packaged articles for sale but may be less important for pallet unitizing.

Conventionally the films used in these applications are multilayer films with a defined stiffness and shrink force in particular in the cold state. Many collation shrink films comprise combinations of low density polyethylene (LDPE), linear low density polyethylene (LLDPE) and/or high density polyethylene (HDPE). See for example EP1529633, EP2653392 and references therein.

U.S. Pat. No. 6,187,397 teaches a 3-layer co-extruded heat-shrinkable film devoid of metallocene polyethylene. U.S. Pat. No. 6,340,532 discloses shrink films manufactured from “pseudohomogeneous” linear low density polyethylene resins preferably prepared with an advanced Ziegler Natta catalyst. U.S. Pat. No. 6,368,545 teaches a high clarity multilayer blown coextruded film prepared using special methods, wherein a film is described having a central core of HDPE.

U.S. Patent Application Publication 2002/0187360 discloses a heat shrinkable, co-extruded polyethylene film laminate having a relatively low melting point core layer comprising a linear low density polyethylene (LLDPE) having a density of 0.910-0.930 g/cm³ and a linear very low density polyethylene (VLDPE) having a density of 0.880-0.915 g/cm³, sandwiched between two relatively higher melting surface layers comprising a linear low density polyethylene and a linear high density polyethylene.

WO 01/44365 describes a homogeneous blend of a metallocene-catalyzed medium density polyethylene (mMDPE) with a low density polyethylene (LDPE) to produce blown films. The blend may be coextruded between layers of LDPE to make blown films taught in the reference as having the good optical properties of LDPE and the good mechanical and processing properties of MDPE.

Additional disclosures of interest include U.S. Pat. No. 6,492,010, U.S. Statutory Invention Registration H2073, WO 95/00333 and EP 0597502.

However, a problem during the production of the finished shrink-wrapped good (pallet or multipack) is that when it is removed from the shrinking oven and allowed to cool down it can deform easily, since the shrink force of conventional films at temperatures between 23° C. and 80° C. is zero during the cooling phase. Furthermore during transportation a deformation or elongation or straining of the film will result in non-uniform deformation as soon as the yield point is surpassed, which is due to the missing “strain hardening” effect of the films used in this application. Strain hardening means that upon deformation of the film, the force necessary for further deformation rises as the deformation and strain increases.

Accordingly, it is desirable to find heat shrinkable films that can overcome this problem.

### SUMMARY OF THE INVENTION

This invention relates to a heat shrinkable multilayer film comprising at least one ionomer layer consisting essentially of a copolymer of ethylene and methacrylic acid or acrylic acid wherein from about 1 to about 99% of the carboxylic acid groups are neutralized to carboxylate salts comprising metal ions, wherein the at least one ionomer layer comprises from 5 to 40 weight % of the multilayer film; and at least one additional layer comprising a polyolefin, wherein the at least one additional layer comprises 60 to 95 weight % of the multilayer film; wherein the film exhibits shrinkage of at least about 5% when exposed to a temperature of about 80 to about 100° C. for about 3 to about 7 minutes but not more than 10% when exposed to a temperature of 80° C. for 10 seconds and not more than 20% when exposed to a temperature of 90° C. for 10 seconds.

Preferably, the multilayer film shows shrinkage of at least 10% when exposed to a temperature of at least 110° C. Optionally, the multilayer film is oriented in a draw ratio of at least 1:3.

The invention also provides a method for collation shrink wrapping an object comprising a plurality of individual product containers or at least one irregularly shaped object, and optionally a tray or pallet, comprising:
(i) obtaining a collation shrink film described above;
(ii) wrapping the object in the collation shrink film;
(iii) heating the object wrapped in the film in order to collation shrink the collation shrink film around the object to provide a collated product.

The invention also provides for use of a collation shrink film as described above to collation shrink wrap an object comprising a plurality of individual product containers or at least one irregularly shaped object, and optionally a tray or pallet, preferably wherein the multilayer film structure is in the form of a generally planar film or sheet; a bag, pouch, hood or sheath, tube or sleeve, or lidding material.

The invention also provides a collated product comprising the film described above wrapped around an object and optionally a tray or pallet, and shrunk to conform around the object.

### DETAILED DESCRIPTION OF THE INVENTION

All references disclosed herein are incorporated by reference.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”. The word(s) following the verb “is” can be a definition of the subject.

The term “consisting essentially of” in relation to film layer materials is to indicate that substantially (greater than 95 weight % or greater than 99 weight %) the only polymer(s) present in a component layer is the polymer(s) recited. Thus this term does not exclude the presence of additives, e.g. conventional film additives; i.e. each layer independently may contain conventional film additives such those described below. Moreover, such additives may possibly be added via a masterbatch that may include other polymers as carriers, so that minor amounts (less than 5 or less than 1 weight %) of polymers other than those recited may be present.

When the term “about” is used in describing a value or an end-point of a range, the disclosure should be understood to include the specific value or end-point referred to.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. A description of a copolymer with reference to its constituent comonomers or to the amounts of its constituent comonomers means that the copolymer contains copolymerized units (in the specified amounts when specified) of the specified comonomers. Polymers having more than two types of monomers, such as terpolymers, are also included within the term “copolymer” as used herein. A dipolymer consists of two copolymerized comonomers and a terpolymer consists of three copolymerized comonomers.

“(Meth)acrylic acid” includes methacrylic acid and/or acrylic acid and “(meth)acrylate” includes methacrylate and/or acrylate.

The term “when exposed to a temperature of” refers to the temperature of the environment around the film such as the temperature of the oven in which the film is placed or the temperature of an oil bath in which the film is placed. It will be appreciated that if the film is present in an oven for a short period of time, the film itself may not heat to the oven temperature. For ease of measurement however, “when exposed to a temperature” refers to the temperature of the environment rather than the actual film temperature.

The term “an object comprising a plurality of individual product containers” means that the object being wrapped is itself formed from a plurality of preferably identical containers such as cans, tins, bottles, jars, plastic liquid dispensers (e.g. shower gel, shampoo, and soap containers), boxes, vials, tubes and so on. The number of such containers making up the object might vary, e.g. from 2 to 64 containers. The skilled person will be familiar with objects that can be wrapped such as a 6-pack of beverage cans, 24-pack of food cans and so on.

The “collated product” as used herein is not a product formed from a large number of small identical units such as rice, sweets or pasta but is based on a plurality of containers that are combined into a single object wrapped in a collation film.

Optionally the multiple containers might be carried on a tray, such as a cardboard tray. In that case, the tray forms part of the object being wrapped.

The containers will typically be arranged in a regular pattern such as a square or rectangle. Containers can have any cross-section such as circular (like bottles and cans), oval, square, rectangular or irregular. The smallest cross-sectional dimension of any container is preferably at least 1 cm. The maximum cross-sectional dimension is preferably 200 cm (the diagonal dimension for rectangular objects such as boxes) in the case of pallet unitizing. In consumer multipacks, containers may not be stacked before wrapping; therefore there may be a single layer of containers to be wrapped. Alternatively, containers may be stacked to provide a plurality of layers of containers, such as in pallet unitizing. For example, a pallet load may comprise from 1 to 20 layers of containers high arranged in arrays of 1 to 10 by 2 to 10 containers, depending on the size and shape of the containers.

A “pallet” as used herein is a low platform constructed of wood, plastic and/or metal on which smaller items are placed for shipping and/or storage.

The films of the invention are multilayer films. In its simplest embodiment, this invention covers a multilayer collation shrink film comprising at least one ionomer layer and at least one additional layer comprising a polyolefin as the major component. Multilayer films are preferably formed from at least three layers, such as 3 layers, 5 layers or 6 layers. Notably, the film structure does not include polyamides (nylons), polyesters such as polyethylene terephthalate (PET), ethylene vinyl alcohol (EVOH), ethylene vinyl acetate (EVA), polyvinylide chloride (PVDC) or other polymers except ionomers and polyolefins as defined herein.

An overall ionomer content of about 5 to 40% in the film composition will provide strain hardening of the film. This reduces the effect of non-uniform deformation of the film and leads to a tighter fitting package.

Furthermore it was surprisingly found that even though the ionomer comprises less than 40% of the entire film, the film exhibits shrinkage of at least about 5% when exposed to a temperature of about 80 to about 100° C. for about 3 to about 7 minutes but not more than 10% when exposed to a temperature of 80° C. for 10 seconds and not more than 20% when exposed to a temperature of 90° C. for 10 seconds. The film also has a shrink force at temperatures below the melting point of the ionomer complimented with a shrink force due to the polyethylene at temperatures higher than 120° C. The shrinkage at temperatures below 100° C. allows for continued shrinkage of the film after the collated object is removed from the heat source.

This unique combination of high and low temperature shrinkage and shrink forces will lead to superior performance in pallet and individual pack shrink film packages and will keep the packs tight during production and transportation.

At least one layer of the multilayer film comprises, or consists essentially of, an ionomeric composition. Ionomeric compositions (“ionomers”) are ionic copolymers of an olefin such as ethylene (E) with a metal salt of an unsaturated carboxylic acid, such as acrylic acid (AA), methacrylic acid (MAA), and/or other acids, and optionally softening comonomers such alkyl acrylates or alkyl methacrylates. At least one alkali metal, transition metal, or alkaline earth metal cation, such as lithium, sodium, potassium, magnesium, calcium, or zinc, or a combination of such cations, is used to neutralize some portion of the acidic groups in the copolymer resulting in a thermoplastic resin exhibiting enhanced properties. Preferred α,β-ethylenically unsaturated monocarboxylic acids include acrylic acid and methacrylic acid, present in the copolymer in about 2 weight % to about 30 weight %. Dipolymers preferably include from about 8 to about 20 weight % of α,β-ethylenically unsaturated monocarboxylic acid. For example, a dipolymer of ethylene and methacrylic acid can then be at least partially neutralized to salts comprising one or more alkali metal, transition metal, or alkaline earth metal cations to form an ionomer.

As indicated above, comonomers such as alkyl (meth)acrylates can be included in the ethylene acid copolymer to form a terpolymer that can be neutralized to provide carboxylate salts with alkali metal, alkaline earth metal or transition metal cations. Preferred are comonomers selected from alkyl acrylate and alkyl methacrylate wherein the alkyl groups have from 1 to 8 carbon atoms, and more preferred are comonomers selected from methyl acrylate, ethyl acrylate, iso-butyl acrylate (iBA), and n-butyl acrylate (nBA). The alkyl (meth)acrylates are optionally included in amounts from 0 to about 30 weight % alkyl (meth)acrylate such as 0.1 to about 30 weight % and preferably from 5 to about 25 weight % of the copolymer when present.

The ethylene acid terpolymer comprises one or more E/X/Y terpolymers where E represents copolymerized units of ethylene, X represents copolymerized units of at least one C₃-C₈ α,β-ethylenically unsaturated carboxylic acid, Y represents copolymerized units of a softening comonomer (softening means that the polymer is made less crystalline).

Examples of X include acrylic acid or methacrylic acid and X can be from about 3 to 35, 4 to 25, or 5 to 20, weight % of the E/X/Y copolymer and ethylene can make up the rest. Examples of Y include alkyl acrylate, alkyl methacrylate, or combinations thereof wherein the alkyl groups have from 1 to 8, or 1 to 4, carbon atoms. E/X/Y copolymers wherein Y is present in at least 1 weight %, or about 2 to about 35 weight % of the E/X/Y copolymer are notable. Ethylene can make up the rest of the E/X/Y terpolymer.

Specific terpolymers include ethylene/acrylic acid/n-butyl acrylate, ethylene/methacrylic acid/n-butyl methacrylate, ethylene/acrylic acid/iso-butyl acrylate, ethylene/methacrylic acid/iso-butyl methacrylate, ethylene/acrylic acid/methyl acrylate, ethylene/methacrylic acid/methyl methacrylate, ethylene/acrylic acid/ethyl acrylate and ethylene/methacrylic acid/ethyl methacrylate terpolymers, or combinations of two or more thereof.

The acid copolymers used herein are preferably “direct” or “random” acid copolymers. Direct or random copolymers are polymers polymerized by adding all monomers simultaneously, as distinct from a graft copolymer, where another monomer is grafted onto an existing polymer, often by a subsequent free radical reaction. Ethylene acid copolymers may be produced by any methods known to one skilled in the art such as use of “co-solvent technology” disclosed in U.S. Pat. No. 5,028,674.

Ionomers are obtained by neutralization of an acid copolymer. Neutralization of the ethylene acid copolymer can be effected by first making the ethylene acid copolymer and treating the copolymer with inorganic base(s) with alkali metal, alkaline earth metal or transition metal cation(s). The copolymer can be from about 1 to about 99% neutralized to form salts with at least one metal ion selected from lithium, sodium, potassium, magnesium, calcium, barium, lead, tin, zinc, aluminum; or combinations of such cations. Neutralization may be from about 10 to about 70%. Preferably the copolymer has from about 20%, alternatively from about 35%, to about 70% of the available carboxylic acid groups ionized by neutralization with at least one metal ion selected from sodium, zinc, lithium, magnesium, and calcium; and more preferably zinc or sodium. Particularly notable is an ionomer comprising zinc cations.

The amount of basic metal compound capable of neutralizing acidic groups may be provided by adding the stoichiometric amount of the basic compound calculated to neutralize a target amount of acid moieties in the acid copolymer (herein referred to as “% nominal neutralization” or “nominally neutralized”). Thus, sufficient basic compound is made available in the blend so that, in aggregate, the indicated level of nominal neutralization could be achieved.

Metal compounds of note include formates, acetates, nitrates, carbonates, hydrogencarbonates, oxides, hydroxides or alkoxides of the ions of alkali metals, especially sodium and potassium, and formates, acetates, nitrates, oxides, hydroxides or alkoxides of the ions of alkaline earth metals and transition metals. Of note are sodium hydroxide, potassium hydroxide, sodium acetate, potassium acetate, sodium carbonate and potassium carbonate.

Unmodified ionomers are prepared from the acid copolymers such as those disclosed in U.S. Pat. No. 3,264,272. “Unmodified” refers to ionomers that are not blended with any material that has an effect on the properties of the unblended ionomer, except the additives described below. Notably, ionomers used in the collation shrink films of the invention comprise less than one weight % of C₆-C₃₆ monocarboxylic acids or salts thereof.

The collation shrink film also includes at least one layer comprising a polyolefin, preferably polyethylene (PE) homopolymers or copolymers of ethylene and other α-olefins. Other α-olefins include propylene, 1-butene, 1-hexene, 4-methyl-1-pentene, 1-octene, 1-decene, 1-tetradecene, 1-octadecene, or in combinations of two or more. It should be appreciated that the list of comonomers above is merely exemplary, and is not intended to be limiting. Various types of polyethylenes are known in the art. PE homopolymers and copolymers may be prepared by a variety of methods, for example, the well-known Ziegler-Natta catalyst polymerization (e.g., U.S. Pat. Nos. 4,076,698 and 3,645,992), metallocene catalyzed polymerization, Versipol® catalyzed polymerization and by free radical polymerization. The polymerization may be conducted as solution phase processes, gas phase processes, and the like. Examples of PE polymers may include high density PE (HDPE), linear low density PE (LLDPE), low density PE (LDPE), very low or ultralow density PEs (VLDPE or ULDPE), lower density PE made with metallocene having high flexibility and low crystallinity (mPE).

The density of PE may range from about 0.865 g/cc to about 0.970 g/cc. Linear PE may incorporate α-olefin comonomers such as butene, hexene or octene to decrease density to within the density range so described. For example, a copolymer may comprise a major portion (by weight) of ethylene that is copolymerized with another α-olefin having 3 to 20 carbon atoms and up to about 20% by weight of the copolymer.

Low density polyethylene (“LDPE”) can be prepared at high pressure using free radical initiators and typically has a density in the range of 0.916 to 0.940 g/cm³, preferably 0.924 to 0.940 g/cm³. LDPE is also known as “branched” or “heterogeneously branched” polyethylene because of the relatively large number of long chain branches extending from the main polymer backbone. Polyethylene in the same density range, 0.916 to 0.940 g/cm³, which is linear and does not contain large quantities of long chain branching is also known; this “linear low density polyethylene” (“LLDPE”) can be produced with conventional Ziegler-Natta catalysts or with single site catalysts such as metallocene catalysts. Relatively higher density LDPE or LLDPE, typically in the range of 0.928 to 0.940 g/cm³ are sometimes referred to as medium density polyethylene (“MDPE”) or Linear Medium Density Polyethylene (LMDPE). Polyethylenes having still greater density are the high density polyethylenes (“HDPEs”), i.e., polyethylenes having densities greater than 0.940 g/cm³, and are generally prepared with Ziegler-Natta catalysts, chrome catalysts or even single site catalysts such as metallocene catalysts. Very low density polyethylene (“VLDPE”) is also known. VLDPEs can be produced by a number of different processes yielding polymers with different properties, but can be generally described as polyethylenes having a density less than 0.916 g/cm³, such as 0.890 to 0.915 g/cm³ or 0.900 to 0.915 g/cm³.

A “metallocene polyethylene” as used herein means a polyethylene produced by a metallocene catalyst, defined to be at least one metallocene catalyst component containing one or more substituted or unsubstituted cyclopentadienyl moiety (Cp) in combination with a Group 4, 5, or 6 transition metal (M). The metallocene catalyst precursors generally require activation with a suitable co-catalyst, or activator, in order to yield an “active metallocene catalyst”, i.e., an organometallic complex with a vacant coordination site that can coordinate, insert, and polymerize olefins. Non-limiting examples of metallocene catalysts and catalyst systems useful in preparing metallocene polyethylenes include WO96/11961; WO96/11960 and WO01/98409; U.S. Pat. Nos. 4,808,561; 5,017,714; 5,055,438; 5,064,802; 5,124,418; 5,153,157; 5,240,894; 5,272,236; 5,264,405; 5,278,272; 5,324,800; 5,507,475, 6,380,122; and 6,376,410; and references cited therein. Of note is metallocene polyethylene comprising ethylene/octene copolymers.

The PE copolymer may also be an ethylene propylene elastomer containing a small amount of unsaturated compounds having a double bond. Ethylene copolymers having small amounts of a diolefin component such as butadiene, norbornadiene, hexadiene and isoprene are also generally suitable. Terpolymers such as ethylene/propylene/diene monomer (EPDM) are also suitable.

Blends of two or more of any of the polyethylene are also contemplated for use in this invention. For example, blends of LLDPE and LDPE or blends of LDPE and HDPE may be used in at least one layer of the multilayer film.

As used herein, the terms “polyethylene” and “PE” are used generically to refer to any or all of the non-ionomeric polymers comprising ethylene described above, including any of the above-described materials and blends.

The composition of each layer in the multilayer film may additionally comprise from 0.01 to 15, 0.01 to 10, or 0.01 to 5, weight %, based on the total composition weight, of additives including plasticizers, stabilizers including viscosity stabilizers and hydrolytic stabilizers, primary and secondary antioxidants, ultraviolet ray absorbers, UV stabilizers, anti-static agents, acid scavengers, nucleating agents, dyes, pigments or other coloring agents, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, other polymer processing agents and so on, or combinations of two or more thereof. The additives may be incorporated into the composition by any known process such as by dry blending, extruding a mixture of the various constituents, the conventional masterbatch technique, or the like.

For some applications, such as pallet unitizing, the composition of the film layer(s) can further comprise a fire retardant such as a chemical additive including, but not limited to, phosphorous compounds, antimony oxides, and halogen compounds, particularly bromine compounds, and others well known in the art. A loading of such additives can be between 20 to 30, or about 25% (of the final air-dried composition or air-dried film weight).

In this invention, a shrink film structure is provided having at least two layers, at least one layer comprising an ionomer and at least one layer comprising polyethylene.

In a two-layer film, the ionomer layer is preferably used as the layer that faces toward the goods to be collated to facilitate heat sealing of the collation film.

Preferably, the collation shrink film comprises 3 or more layers.

As used herein, the term “skin layer” means that the layer is an outer or surface layer of the structure. Thus, in a three-layer structure there are two skin layers and a core layer, sandwiched by the skin layers. This structure will be denoted A/B/A, wherein the A layer denotes a skin layer, and the B layer denotes the core layer. It will be recognized that the A layers do not need to be identical, however. The final film comprising the A/B/A structure may be symmetrical or it may be unsymmetrical.

The skin layer facing the objects to be collated may be preferably involved in sealing of the film (to itself). In some embodiments the skin layer(s) may preferably comprise slip or antiblock additives, while inner or core layers may not.

For example, a 3-layer film comprises an inner core layer comprising polyethylene and two surface layers comprising an ionomer, wherein the inner layer comprises from 60 to 95% of the total film and the ionomer surface layers each independently comprise about 2 to about 20% of the film. A specific embodiment is a 3-layer film comprising an inner core layer comprising a blend of LDPE and HDPE, such as a blend comprising 70 to 90 weight % of LDPE and 10 to 30 weight % of HDPE. Another embodiment is a 3-layer film comprising an inner core layer comprising a blend of LDPE and LLDPE, such as a blend comprising 70 to 90 weight % of LDPE and 10 to 30 weight % of HDPE. The LDPE used in the core layer may have a density in the range of 0.916 to 0.935 g/cm³, preferably 0.916 to 0.927 g/cm³, and more preferably 0.921 to 0.926 g/cm³. Other embodiments include LDPEs having densities from any of the lower density limits specified to any of the higher density limits specified herein, for example, 0.921 to 0.940 g/cm³ and 0.926 to 0.940 g/cm³.

Alternatively, a 3-layer film comprises an inner core layer of ionomer and two surface layers comprising polyethylene, such that the inner core layer comprises from about 5 to about 40% of the total film and each surface layer independently comprises from about 20 to about 50% of the total film. A specific embodiment is a 3-layer film comprising surface layers comprising a blend of LDPE and LLDPE, such as a blend comprising 70 to 95 weight % of LLDPE and 5 to 30 weight % of LDPE.

Additional film layers are contemplated, for example tie layers may be positioned between one or both of the A/B layers to improve interlayer adhesion.

Other embodiments include 5-layer structures, such as A/B/C/B/A structures in which the A skin layers comprise polyethylene, B inner layers comprise an ionomer and C core layers comprise polyethylene. Notable embodiments include structures wherein the skin layer(s) comprise LLDPE, LDPE or a blend of LLDPE and LDPE, such as a blend comprising 70 to 95 weight % of LLDPE and 5 to 30 weight % of LDPE. Embodiments also include those wherein the core layer comprises a blend of LLDPE and LDPE, such as a blend of 5 to 30 weight % of LLDPE and 70 to 95 weight % of LDPE; or wherein the core layer comprises a blend of 70 to 90 weight % of LDPE and 10 to 30 weight % of HDPE. Preferably, the core layer is thicker than the other layers.

The multilayer film may be prepared according to well-known film preparation techniques, including cast film coextrusion, blown film coextrusion, extrusion coating or extrusion lamination.

A multilayer film can be prepared by coextrusion as follows: granulates of the various components for each layer are melted in suitable extruders and converted into a film using a converting technique. For coextrusion, the molten polymers are passed through a die or set of dies to form layers of molten polymers that are processed as a layered flow and then cooled to form a layered structure. The film may be further oriented beyond the immediate quenching or casting of the film. In general terms the process comprises the steps of coextruding a multilayer flow of molten polymers, quenching the coextrudate and orienting the quenched coextrudate in at least one direction. The film may be uniaxially oriented, or it may be biaxially oriented by drawing in two mutually perpendicular directions in the plane of the film to achieve a satisfactory combination of mechanical and physical properties.

Cast films are prepared by passing the extrudate through a slot die and passing it through nip rollers.

A preferred film is a blown film obtained through blown film extrusion. Generally, the compositions of the various layers are fed from extruders to an annular die and blown by blown extrusion to form a bubble that is converted into a tubular film. Blown films are to some extent biaxially oriented depending on the blow up ratio. Orientation in the transverse direction is due to the increase in diameter of the bubble as the polymeric material exits the annular die and orientation in the machine direction is due to stretching of the bubble during blowing. Blow extrusion and stretching techniques are well known in the art; see for example EP299750.

Alternatively for ABCCBA type film structures, the film can advantageously be prepared first by coextruding compositions forming the layers A, B and C through an annular die, and blowing by blown extrusion into a tubular film to form a bubble. The formed bubble is then collapsed e.g. in nip rolls to form a film where the C layers are contacted inside/inside, i.e. ABC/CBA. Alternatively, the coextruded bubble may be collapsed and split into two films. The two films can then be stretched separately in a winding machine (2×ABC films).

Orientation and stretching methods to uniaxially or biaxially stretch film are known in the art and may be adapted by those skilled in the art to produce the films of this invention. Examples of such apparatus and processes include e.g. those disclosed in U.S. Pat. Nos. 3,278,663; 3,337,665; 3,456,044; 4,590,106; 4,760,116; 4,769,421; 4,797,235 and 4,886,634.

The films may be optionally further oriented uniaxially in the machine direction by stretching but not oriented further in the transverse direction. That means that they are stretched in a single direction, the machine direction after the actual blown film extrusion. The preparation of a uniaxially oriented multilayer film of the invention can comprise at least the steps of forming a layered film structure in a blown film process with a blow up ratio of at least 1.5, preferably at least 2.0 or higher and stretching the obtained multilayer film in a draw ratio of at least 1:3.

Typically the compositions providing the layers of the film will be blown i.e. (co)extruded at a temperature in the range 160° C. to 240° C., and cooled by blowing gas (generally air) at a temperature of 10 to 50° C. to provide a frost line height of 1 or 2 to 8 times the diameter of the die. The blow up ratio should generally be in the range 1.2 to 6, preferably 1.5 to 4.

The film may be stretched only in the machine direction to be essentially uniaxially oriented. Stretching is preferably carried out at a temperature in the range 70 to 90° C., e.g. about 80° C. Any conventional stretching rate may be used, e.g. 2 to 40% per second.

The film may be stretched at least 3 times, preferably 3 to 10 times, its original length in the machine direction. This is stated herein as a draw ratio of at least 1:3, i.e. “1” represents the original length of the film and “3” denotes that it has been stretched to 3 times that original length. Preferred films are stretched in a draw ratio of at least 1:4, more preferably between 1:5 and 1:8, such as between 1:5 and 1:7. An effect of stretching (or drawing) is that the thickness of the film is similarly reduced. Thus a draw ratio of at least 1:3 preferably also means that the thickness of the film is at least three times less than the original thickness.

The films of the invention typically have a starting (or original) thickness of 400 μm or less, preferably 40 to 300 μm, more preferably 50 to 250 μm prior to the stretching step.

After stretching, the final thickness of the oriented films of the invention is typically 50 μm or less, preferably 10 to 50 μm, more preferably 15 to 40 μm, still more preferably 20 to 38 μm, e.g. 25 to 38 μm, especially 28 to 32 μm.

When subjected to heat, such as in the shrink tunnel, the films shrink by at least 10%, preferably the films contract by between 40 and 85% such as 50 to 80%, such as 60 to 75%. This shrinkage ratio represents the total shrink of the film, i.e. that which occurs during the heating process in the tunnel/oven and the shrinkage which occurs during the cooling process.

For primarily uniaxially oriented films, it is preferred that the film of the invention shrinks by at least 50% in the machine direction even when exposed to heat of 170° C. or less. It is preferred if the films of the invention shrink by at least 50% in the machine direction at temperatures of between 80 and 160° C., such as 90 to 150° C. Shrink in the transverse direction can be up to 10%, especially in the temperature range of 90 to 170° C.

The films of the invention preferably have high stiffness before the shrink process. Higher stiffness allows the collation shrink film to be easily handled. Film stiffness before shrinkage may be 100 to 1000 MPa, preferably 100 to 500 MPa. The material may have high penetration energy to withstand sharp objects. Penetration resistance values maybe of the order of 80 to 150 milijoules (mJ)/mm before shrinkage measured according to DIN EN ISO 6603-2 or equivalent standards

Bundling force or cold shrink force is preferably above 2 N in the machine direction.

The films of the invention preferably have a haze value of less than 20% according to ASTM D1003-13 before shrinkage.

Embodiments of the multilayer film include:
The multilayer film which shows shrinkage of at least 10% when exposed to a temperature of at least 110° C.
The multilayer film wherein the film is oriented in a draw ratio of at least 1:3.
The multilayer film wherein the polyolefin comprises high density polyethylene, linear low density polyethylene, low density polyethylene, very low or ultralow density polyethylene, or metallocene low density polyethylene or combinations thereof.
The multilayer film comprising at least three layers.
The multilayer film comprising an inner core layer comprising polyethylene and two surface layers comprising an ionomer, wherein the inner layer comprises from 60 to 95% of the total film and the ionomer surface layers each independently comprise about 2 to about 20% of the film.
The multilayer film comprising an inner core layer comprising a blend of LDPE and HDPE.
The multilayer film comprising an inner core layer comprising a blend of LDPE and LLDPE.
The multilayer film wherein the core layer comprises a blend of LLDPE, HDPE and LDPE.
The multilayer film comprising an inner core layer of ionomer and two surface layers comprising polyethylene, such that the inner core layer comprises from about 5 to about 40% of the total film and each surface layer independently comprises from about 20 to about 50% of the total film.
The multilayer film comprising surface layers comprising a blend of LDPE and LLDPE.
The multilayer film comprising at least five layers.
The multilayer film having an A/B/C/B/A structure in which the A skin layers comprise polyethylene, B inner layers consist essentially of the ionomer and C core layers comprise polyethylene.
The multilayer film wherein at least one A layer comprises LLDPE, LDPE or a blend of LLDPE and LDPE.
The multilayer film wherein at least one A layer comprises a blend comprising 70 to 95 weight % of LLDPE and 5 to 30 weight % of LDPE.
The multilayer film wherein the core layer comprises a blend comprising LLDPE and LDPE.
The multilayer film wherein the core layer comprises a blend comprising LLDPE and HDPE.
The multilayer film wherein the core layer comprises a blend comprising LLDPE, HDPE and LDPE.
The multilayer film wherein the core layer comprises a blend comprising 5 to 30 weight % of LLDPE and 70 to 95 weight % of LDPE.
The multilayer film wherein the core layer comprises a blend comprising 70 to 90 weight % of LDPE and 10 to 30 weight % of HDPE.
The multilayer film wherein the core layer comprises a blend comprising 30 to 80 weight % of LLDPE, 10 to 50 weight % of LDPE and 10 to 30 weight % of HDPE.
The multilayer film wherein the core layer is thicker than the other layers.
The multilayer film wherein the yield stress of the film in the machine direction (MD) is at least 12 MPa, or is at least 25% higher than the yield stress of a corresponding film without ionomer when stretched by 50%; and the strain hardening regime from 100 to 200% of elongation of the film is characterized by a continuous increase of stress of at least 2 MPa in the machine direction.
The multilayer film wherein the holding stress at 200% deformation at 23° C. is at least 25% higher, or at least 33% higher, than a corresponding film without ionomer.
The multilayer film having a distinct yield point and wherein strain hardening is retained at higher temperature when ionomer is present in the structure compared to a corresponding film without ionomer.
The multilayer film wherein at elevated temperatures the tensile strength or hold stress is higher than that of a corresponding film without ionomer at the corresponding temperature.
The multilayer film wherein the holding stress at 200% deformation at 40° C. and 50° C. of Example 3 is at least 40% higher than that of a corresponding film without ionomer at the corresponding temperature.
The multilayer film wherein the holding stress at 200% deformation at 50° C. is higher than that of a corresponding film without ionomer at 40° C.

The mechanical properties and ease of processing of the shrink film composition render collation films applicable for covering, containing or enclosing articles or objects during transport and storage to provide protection and unitizing. Articles for this use include:

(1) films or sheets of material comprising the shrink film structure that may be wrapped around or draped over the objects being packaged such as pallet wrapping films and the like and subsequently heat shrunk to conform tightly around the objects;

(2) bags, pouches, hoods or sheathes comprising the shrink film structure described herein, including heat shrinkable pallet hoods that are placed over the objects to be collated and subsequently heat shrunk to conform tightly around the objects;

(3) tubes or sleeves comprising the shrink film structure described herein that may be wrapped around the objects and subsequently heat shrunk to conform tightly around the objects;

(4) lidding material comprising the shrink film structure. The lidding material may be used in combination with rigid or semi-rigid or flexible structures such as tubs, boxes, bins and the like to prepare a package comprising the shrink film structure.

### Collation Shrink Process

The invention provides a method for collation shrink wrapping an object comprising a plurality of individual product containers, comprising:
(i) obtaining a collation shrink film as described herein, including any embodiments of the multilayer film described above;
(ii) wrapping the object in the collation shrink film;
(iii) heating the object wrapped in the film in order to collation shrink the collation shrink film around the object to provide a collated product.

The collation shrink process is generally described below in its most common form, in which the collation film is in the form of continuous rolls that are wrapped around the objects to be collated in a continuous sequence. Other variations of this process using different forms of the film can be envisioned.

The collation shrink film of the invention can be wrapped around an object in a conventional manner The collation shrink film is typically supplied in a large roll in its stretched form. Film is dispensed from the roll, cut and placed over (i.e. above) the object to be wrapped. The film is cut into appropriate lengths as it is dispensed from the roll.

Generally the objects to be collation shrink wrapped will be present on a conveyor belt or other conveying means. The wrapping process is a continuous process so the conveyor will contain a plurality of objects to be wrapped. As each object moves along the conveyor, the collation shrink film is moved over the top of the object and then wrapped over it, down two opposite sides and underneath it using conventional equipment. The two ends of the film are therefore brought together and contacted underneath the object. These ends form a seal during the later shrink process or can be sealed using sealing bars as described later. In some embodiments, tubular films may be used to wrap around the objects to be collated, thereby obviating the need to heat seal around the bottom of the object. The other two sides of the object remain open but the film used will be longer than the object so that there will be film protruding around the open ends. In the shrink tunnel, this film shrinks and folds in to wrap those open ends. A hole is still left in the “open ends” as is known.

It is preferred if the two sides of the object (i.e. the sides in addition to the top and bottom of the object) covered by the film are the long sides of the object. Thus in a 3×2 bottle arrangement, it is the side of 3 bottles which is covered and the side with 2 bottles which remains open.

For pallet unitizing, film may be dispensed from a roll and wrapped around the sides and optionally the top of the pallet in overlapping fashion to sufficiently cover and contain the objects to be unitized. In some cases the film may be carried around a stationary pallet to wrap it. Alternatively, the pallet may be placed on a rotating platform and turned as the film is dispensed from a stationary dispensing station. The film-wrapped pallet may be heated to shrink the film tightly around the collated objects.

Preferably for pallet unitizing, the film is pre-formed into a hood dimensioned to be pulled over the pallet load and subsequently heat shrunk Shrink hoods may be preferably at least to some extent biaxially oriented to enable good shrinkage around all sides of the pallet load.

The wrapped object is then heated in some fashion to enable the collation shrink process and if necessary also to seal the collation shrink film to itself underneath and/or around the object. Typically, the wrapped object is passed through a heat tunnel in order to shrink the film around the object. The machine direction of the shrink tunnel is also the MD direction of the film.

Current shrink tunnels typically employ temperatures of 180 to 210° C. This exposes therefore the material being packaged to high temperature albeit for a short period of time. It is perceived however that these high temperatures are required to enable the necessary collation shrinkage properties and to effect a seal of the film underneath the object.

It is a major benefit of the use of the collation shrink films of the invention that commercially relevant levels of machine direction shrinkage can be achieved at much lower temperatures. The temperature to which the collation shrink films of this invention are exposed may be up to 170° C., preferably up to 160° C., such as 80 to 150° C. Preferably the temperature is in the range of 90 to 140° C. Note that what matters is the temperature which the film experiences. In order to ensure that the film experiences a particular temperature, it may be that the shrink tunnel has to be a little warmer than that temperature. In terms of the temperatures experience by the film itself, useful shrink properties may result when the actual film temperature is 140° C. or less such as 80 to 135° C., especially 90 to 130° C.

For the targeted machine direction oriented films of this invention, the tunnel temperature could be reduced to 130 to 170° C. for example, in order to make sure that the collation shrink films within the tunnel experience the temperatures mentioned above. Low shrinkage temperatures might however lead to poor film sealing. It may therefore be necessary to use sealing bars to effect a seal of the two ends of the collation shrink film of the invention. This may be carried out before the object is exposed to shrink temperatures, such as by passing the wrapped object over a sealing bar as it moves along the conveyor before entering the shrink tunnel.

The object may spend up to one minute in the heated zone in order to ensure that the collation shrink wrapping occurs, such as for 20 to 30 seconds.

In general, the collation shrink wrapping process is known to the person skilled in the art. This invention concerns the nature of the film used to carry out the shrink wrapping.

Embodiments of the method include:
The method wherein the collation shrink film of (i) is supplied on a roll and (ii) comprises dispensing the collation shrink film from the spool and cutting the film into an appropriate length to wrap around the object.
The method wherein the collation shrink film is heat sealed to itself to wrap around the object.
Use of a multilayer film structure as described herein to collation shrink wrap an object comprising a plurality of individual product containers or at least one irregularly shaped object.
Use of a multilayer film structure as described herein wherein the multilayer film structure is in the form of a generally planar film or sheet; a bag, pouch, hood or sheath, tube or sleeve, or lidding material.

The collation shrink films of the invention are preferably used in the wrapping of household, food, healthcare or beverage products, in particular products that are packaged in containers such as bottles, cans, jars, boxes, buckets, tubs, barrels and the like.

Wherever a product is shipped in numerous essentially identical containers, the use of collation shrink film is useful to prevent damage to the products and keep the product secure during transport. The most common application is therefore in the beverage or food transportation market.

It will be appreciated that the collation shrink film might also be used to wrap non-food products such as chemicals, cleaning products and the like.

When used for pallet unitizing, films of the invention may be used to collate a wide variety of objects, including a plurality of containers including bottles, cans, jars, boxes, buckets, tubs, bags, barrels or the like, or it may be used to cover and protect at least one irregularly shaped object such as machinery, furniture and the like.

Embodiments of a collated product include:
The collated product comprising the film described herein wrapped around an object and optionally a tray or pallet, and shrunk to conform around the object.
The collated product wherein the object comprises a plurality of individual product containers, preferably wherein the containers comprise bottles, boxes, cans, buckets, tubs, or barrels, or wherein the object comprises at least one irregularly shaped object including machinery or furniture.
The collated product comprising multilayer film structure as described herein wrapped around an object comprising a plurality of individual product containers and shrunk to conform around the object.
The collated product comprising a tray or pallet and a plurality of containers including boxes, cans, buckets, or barrels.
The collated product comprising a pallet and at least one irregularly shaped object including machinery or furniture.

The following Examples are presented to demonstrate and illustrate, but are not meant to unduly limit the scope of the invention.

### EXAMPLES

### Materials Used

ION-1: Ionomer comprising a dipolymer comprising ethylene and methacrylic acid (12 weight percent), 37% neutralized to carboxylate salts with zinc cations, with MI of 1.8 g/10 minutes.

LLDPE-1: A butene-linear low density polyethylene with density of 0.918 g/cm³, melting point of 121° C. and MI of 1.0 g/10 minutes, commercially available under the designation 118NE from Saudi Basic Industries (SABIC) Europe.

LLDPE-2: linear low density polyethylene with density of 0.918 g/cm³, melting point of 121° C. and MI of 2.8 g/10 minutes, commercially available under the designation 318BE from Saudi Basic Industries (SABIC) Europe.

LDPE: A low density polyethylene with density of 0.922 g/cm³, melting point of 121° C. and MI of 0.85 g/10 minutes, commercially available under the designation 2201TH00 from Saudi Basic Industries (SABIC) Europe.

HDPE: a high density polyethylene homopolymer with density of 0.961 g/cm³ and MI of 0.7 g/10 minutes, commercially available under the designation HTA108 from ExxonMobil™.

MPE1: a medium density ethylene-hexene copolymer with density of 0.935 g/cm³ and MI of 0.5 g/10 minutes, commercially available under the designation Enable® 35-05HH from ExxonMobil™.

Melt Index (MI), the mass rate of flow of a polymer through a specified capillary under controlled conditions of temperature and pressure, was determined and/or reported according to ASTM 1238 at 190° C. using a 2160 g weight, in g/10 minutes.

Penetration resistance was measured according to DIN EN ISO 6603-2. Tensile properties were measured according to ASTM 882 using a tensile testing machine made by Zwick, Model 1465. The tests at elevated temperatures were done using a tensile testing machine made by Zwick, model Z 2.5 according to the same standard. Haze was tested according to ASTM D1003-13 with a Hazemeter M57 manufactured by Diffusion systems Ltd.

Five-layer blown films with ABCBA structure were prepared using the conditions summarized in Tables 1 to 7. In the Tables, Layer 1 was the outside surface layer of the tubular bubble, layer 5 was the inside surface layer of the bubble and layers 2, 3 and 4 were interior layers. The layers in the Comparative Example films all comprised only polyethylene compositions. When adjacent interior layers have the same composition, the combined layers form a single core layer. Comparative Example C4 replaced the LLDPE-2/LDPE blend in the B layers with MPE1. The Example films replaced a fraction of the total interior layers of the Comparative films with ionomer B layers.

TABLE 1
Comparative Example C1

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-1/LDPE 80/20 | 6 | 30.4 | 50 | 12.3 | 222 | 192 | 179 | 200 | 209 | 220 | 220 | 220 |
| 2 | LLDPE-1/LDPE 20/80 | 6 | 30.7 | 35 | 11.3 | 217 | 197 | 179 | 199 | 209 | 220 | 220 | 219 |
| 3 | LLDPE-1/LDPE 20/80 | 16 | 77.7 | 48 | 29.5 | 226 | 279 | 180 | 200 | 210 | 220 | 220 | 220 |
| 4 | LLDPE-1/LDPE 20/80 | 6 | 30.4 | 34 | 10.7 | 217 | 212 | 179 | 199 | 209 | 219 | 220 | 220 |
| 5 | LLDPE-1/LDPE 80/20 | 6 | 30.8 | 50 | 11.9 | 224 | 240 | 180 | 200 | 210 | 219 | 219 | 220 |

| | | | | | | | |
|---|---|---|---|---|---|---|---|
| Nominal Total gauge [μm] | 40 | Total | 81.8 | Line Speed [m/min] | 16.6 | Blow Up Ratio | 2.8 |

TABLE 2
Example 1

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-1/LDPE 80/20 | 6 | 30.6 | 49 | 12.4 | 223 | 185 | 179 | 200 | 209 | 220 | 220 | 220 |
| 2 | ION-1 | 6 | 30.7 | 41 | 14.4 | 216 | 131 | 179 | 199 | 209 | 220 | 220 | 219 |
| 3 | LLDPE-1/LDPE 20/80 | 16 | 77.7 | 48 | 29.9 | 226 | 273 | 180 | 200 | 210 | 220 | 220 | 220 |
| 4 | ION-1 | 6 | 30.4 | 41 | 13.2 | 215 | 137 | 179 | 199 | 209 | 219 | 220 | 220 |
| 5 | LLDPE-1/LDPE 80/20 | 6 | 30.8 | 50 | 11.9 | 224 | 229 | 180 | 200 | 210 | 219 | 219 | 220 |

| | | | | | | | |
|---|---|---|---|---|---|---|---|
| Nominal Total gauge [μm] | 40 | Total | 81.8 | Line Speed [m/min] | 16.6 | Blow Up Ratio | 2.8 |

TABLE 3
Comparative Example C2

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-1/LDPE 95/5 | 6 | 28 | 48 | 11.4 | 222 | 192 | 179 | 230 | 240 | 250 | 250 | 249 |
| 2 | LDPE-1/HDPE 80/20 | 6 | 30.2 | 32 | 11.2 | 217 | 197 | 179 | 200 | 210 | 220 | 220 | 220 |
| 3 | LDPE-1/HDPE 80/20 | 16 | 79.2 | 45 | 29.3 | 226 | 279 | 180 | 199 | 210 | 220 | 219 | 220 |
| 4 | LDPE-1/HDPE 80/20 | 6 | 30.2 | 31 | 10.5 | 217 | 212 | 180 | 200 | 209 | 219 | 219 | 220 |
| 5 | LLDPE-1/LDPE 80/20 | 6 | 29.4 | 45 | 11.2 | 224 | 240 | 179 | 229 | 240 | 250 | 250 | 249 |

| | | | | | | | |
|---|---|---|---|---|---|---|---|
| Nominal Total gauge [μm] | 40 | Total | 73.6 | Line Speed [m/min] | 16.6 | Blow Up Ratio | 2.8 |

TABLE 4
Example 2

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-1/LDPE 95/5 | 6 | 28.8 | 54 | 11.9 | 231 | 173 | 179 | 200 | 220 | 229 | 230 | 230 |
| 2 | ION-1 | 6 | 26.8 | 40 | 12.8 | 215 | 125 | 179 | 200 | 210 | 220 | 220 | 230 |
| 3 | LDPE-1/HDPE 80/20 | 16 | 77.6 | 44 | 29.1 | 223 | 242 | 179 | 200 | 209 | 219 | 220 | 220 |
| 4 | ION-1 | 6 | 27.3 | 40 | 12 | 214 | 130 | 180 | 200 | 210 | 220 | 220 | 220 |
| 5 | LLDPE-1/LDPE 95/5 | 6 | 29.9 | 45 | 12.7 | 251 | 202 | 178 | 229 | 240 | 250 | 250 | 249 |

| | | | | | | | |
|---|---|---|---|---|---|---|---|
| Nominal Total gauge [μm] | 40 | Total | 78.5 | Line Speed [m/min] | 16.6 | Blow Up Ratio | 2.8 |

TABLE 5
Comparative Example C3

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-2/LDPE/HDPE 60/10/30 | 6 | 31.6 | 38 | 12.8 | 220 | 127 | 180 | 199 | 210 | 220 | 220 | 220 |
| 2 | LLDPE-2/LDPE 80/20 | 6 | 31.3 | 37 | 12.7 | 217 | 148 | 179 | 199 | 209 | 220 | 220 | 220 |
| 3 | LLDPE-2/LDPE/HDPE 30/50/20 | 16 | 85.2 | 53 | 32.6 | 227 | 258 | 179 | 200 | 209 | 219 | 220 | 220 |
| 4 | LLDPE-2/LDPE 80/20 | 6 | 31.3 | 35 | 12.2 | 218 | 155 | 179 | 199 | 209 | 219 | 219 | 219 |
| 5 | LLDPE-2/LDPE/HDPE 60/10/30 | 6 | 30.8 | 38 | 12.2 | 221 | 150 | 180 | 200 | 210 | 220 | 220 | 219 |

| | | | | | |
|---|---|---|---|---|---|
| Nominal Total gauge [μm] | 40 | Total | 82.5 | Blow Up Ratio | 2.0 |

TABLE 6
Example 3

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-2/LDPE/HDPE 60/10/30 | 6 | 31.3 | 38 | 12.7 | 220 | 126 | 180 | 199 | 210 | 219 | 220 | 219 |
| 2 | ION-1 | 6 | 30.0 | 39 | 14.8 | 216 | 114 | 175 | 201 | 209 | 218 | 220 | 220 |
| 3 | LLDPE-2/LDPE/HDPE 30/50/20 | 16 | 83.1 | 53 | 32.6 | 226 | 254 | 179 | 197 | 212 | 223 | 219 | 220 |
| 4 | ION-1 | 6 | 30.9 | 37 | 14.1 | 217 | 117 | 178 | 201 | 208 | 218 | 220 | 220 |
| 5 | LLDPE-2/LDPE/HDPE 60/10/30 | 6 | 30.8 | 37 | 12.1 | 221 | 147 | 179 | 200 | 210 | 219 | 220 | 219 |

| | | | | | |
|---|---|---|---|---|---|
| Nominal Total gauge [μm] | 40 | Total | 86.3 | Blow Up Ratio | 2.0 |

TABLE 7
Comparative Example C4

| | | Gauge | Extruder | | | Melt | | Barrel Temperature Settings [° C.] | | | | | |
|---|---|---|---|---|---|---|---|---|---|---|---|---|---|
| Layer | Layer Composition | [μm] | RPM | I [%] | Kg/hr | T [° C.] | P [bar] | Z1 | Z2 | Z3 | Z4 | MCF | BR1 |
| 1 | LLDPE-2/LDPE/HDPE 60/10/30 | 6 | 31.3 | 38 | 12.6 | 220 | 121 | 179 | 200 | 210 | 219 | 219 | 220 |
| 2 | MPE1 | 6 | 30.0 | 51 | 12.4 | 218 | 211 | 176 | 200 | 206 | 215 | 220 | 219 |
| 3 | LLDPE-2/LDPE/HDPE 30/50/20 | 16 | 85.6 | 53 | 33.3 | 226 | 253 | 182 | 199 | 199 | 222 | 220 | 220 |
| 4 | MPE1 | 6 | 30.4 | 49 | 11.6 | 221 | 229 | 177 | 200 | 206 | 216 | 220 | 219 |
| 5 | LLDPE-2/LDPE/HDPE 60/10/30 | 6 | 30.9 | 37 | 12.2 | 221 | 148 | 180 | 200 | 209 | 220 | 220 | 219 |

| | | | | | |
|---|---|---|---|---|---|
| Nominal Total gauge [μm] | 40 | Total | 82.1 | Blow Up Ratio | 2.0 |

TABLE 8

| | Comparative Example C5 | Gauge | Example 5 | Gauge |
|---|---|---|---|---|
| Layer | Layer Composition | [μm] | Layer Composition | [μm] |
| 1 | LLDPE-2/LDPE/HDPE 60/10/30 | 6 | LLDPE-2/LDPE/HDPE 60/10/30 | 6 |
| 2 | LLDPE-2/LDPE 80/20 | 6 | ION-1 | 6 |
| 3 | LLDPE-2/LDPE/HDPE 60/10/30 | 16 | LLDPE-2/LDPE/HDPE 60/10/30 | 16 |
| 4 | LLDPE-2/LDPE 80/20 | 6 | ION-1 | 6 |
| 5 | LLDPE-2/LDPE/HDPE 60/10/30 | 6 | LLDPE-2/LDPE/HDPE 60/10/30 | 6 |
| | Nominal Total gauge [μm] | 40 | Nominal Total gauge [μm] | 40 |

The properties of the films including penetration testing, tensile properties and haze are summarized in Table 9. The Example films exhibited strain hardening and no yield point compared to the Comparative Example films. Higher penetration resistance, higher tensile strength and stiffness and lower haze were also exhibited by the Example films compared to the Comparative Example films without ionomer layers.

Table 9 also summarizes the shrink performance of the films under various heat and time conditions. Shrinkage was 0% with short duration heating temperatures below 90° C. for all samples. At higher temperature and longer exposure times, shrinkage in MD was still very low.

Importantly, Table 9 summarizes the holding stress and strain hardening conditions of the Example films and clearly illustrates that they show a high strain hardening behavior and a high holding stress after minimum deformation of 50% in both MD and TD compared to Comparative Example films. It can be seen from the results in Table 9 that the introduction of MPE1 in the B layers provides a strain hardening behavior in the stress-strain curve but maintains or even reduces the low yield point and yield stress at 50% deformation, which is associated with a low holding force. On the other hand, introducing ION-1 in the B layers significantly increases the yield stress at 50% deformation and maintains the strain hardening behavior in the stress strain regime.

As shown in Table 10, Example 3 shows improved tensile properties at elevated temperatures (23° C., 40° C. and 50° C.) compared to a structure not containing ionomer (C3). As can be seen, strain hardening is retained even at higher temperature when ionomer is present in the structure and so is a distinct yield point. At 23° C. the holding stress at 200% deformation of Example 3 is at least 25% higher, or at least 33% higher, than C3. What is more interesting is that even at elevated temperatures the tensile strength or hold stress of the ionomer-containing structure Example 3 is higher than the corresponding comparative example C3 at the corresponding temperature. At 40° C. and 50° C. the holding stress at 200% deformation of Example 3 is at least 40% higher than C3. Even more surprising is that the holding stress at 200% deformation of Example 3 at 50° C. is higher than the one of C3 at 40° C. This is a surprising result, given that the melt point of ionomers like ION-1 is 20° C. lower compared to polyethylene known from the literature. Therefore the structure in Example 3 is in a better position to more tightly hold together a package or a pallet of several articles than the film C3, in particular at elevated temperatures such as 40° C. or 50° C., which are common in the interior of a truck when standing in traffic.

TABLE 9

| Example | | | | C1 | 1 | C2 | 2 | C3 | 3 | C4 |
|---|---|---|---|---|---|---|---|---|---|---|
| Penetration Test | Work at break (mJ) | | | 3.29 | 3.55 | 2.96 | 3.62 | 3.56 | 3.6 | 3.1 |
| | Thickness (μm) | | | 49 | 47 | 41 | 41 | 42.7 | 47.3 | 40.7 |
| | Results (J/mm) | | | 0.07 | 0.08 | 0.07 | 0.09 | 0.08 | 0.08 | 0.08 |
| Tensile Properties | E-modulus (MPa) | | MD | 136.3 | 110.5 | 228 | 284.2 | 132 | 143 | 245 |
| | | | TD | 208.2 | 122.4 | | | 157 | 174 | 246 |
| | Tensile Strength (MPa) | | MD | 20.4 | 19.8 | 21.9 | 33.4 | 21.1 | 28.6 | 18.1 |
| | | | TD | 23.5 | 20.1 | | | 15.07 | 24.5 | 18.1 |
| | Elongation at break (mm) | | MD | 414.1 | 783.7 | 201.5 | 274.5 | 514 | 306 | 647 |
| | | | TD | 221.1 | 463.8 | | | 905 | 550 | 843 |
| | Yield Point | | | Yes | No | Yes | No | No | No | No |
| | Strain Hardening | | | No | Yes | No | Yes | No | Yes | Yes |
| | Increase at 100-200% | | MD | 1.7 | 3 | 1.5 | 4.6 | 0.8 | 3.2 | 1.6 |
| | deformation (MPa) | | TD | 0 | 2 | | | | | |
| Holding Stress (MPa) | at 50% deformation | | MD | 12.5 | 18 | 17 | 23 | 14 | 18.2 | 11 |
| | | | TD | 9 | 12 | N/A | N/A | 9 | 12 | N/A |
| Haze (%) | | | | 7.7 | 6.4 | 6.1 | 5.1 | | | |
| | Temperature | Time | | | | | | | | |
| Shrink Test (%) | 80° C. | 10 seconds | MD | 0 | 0 | 0 | 0 | 0 | 0 | 0 |
| | | | TD | 0 | 0 | 0 | 0 | 0 | 0 | 0 |
| | 90° C. | 10 seconds | MD | 0 | 0 | 0 | 0 | | | |
| | | | TD | 0 | 0 | 0 | 0 | | | |
| | 95° C. | 5 minutes | MD | 0 | 5 | N/A | N/A | | | |

| | | | | |
|---|---|---|---|---|
| TD | 0 | 0 | N/A | N/A |

TABLE 10
Tests at Elevated Temperatures

| | | | Example | |
|---|---|---|---|---|
| | | Temperature | C3 | 3 |
| Holding Stress (MPa) | TD | 23° C. | 15-16 | 20-23 |
| at 200% deformation | | 40° C. | 11-12 | 17-18 |
| | | 50° C. | 8-9 | 12-14 |
| Yield Point | TD | 23, 40 and 50° C. | Yes | No |
| Strain Hardening | TD | 23, 40 and 50° C. | No | Yes |

1. A heat shrinkable multilayer film comprising
at least one ionomer layer consisting essentially of a copolymer of ethylene and methacrylic acid or acrylic acid wherein from about 1 to about 99% of the carboxylic acid groups are neutralized to carboxylate salts comprising metal ions, and wherein the at least one ionomer layer comprises from 5 to 40 weight % of the multilayer film; and
at least one additional layer comprising a polyolefin, wherein the at least one additional layer comprises 60 to 95 weight % of the multilayer film;
wherein the film exhibits shrinkage of at least about 5% when exposed to a temperature of about 80 to about 100° C. for about 3 to about 7 minutes; shrinkage of not more than 10% when exposed to a temperature of 80° C. for 10 seconds; and shrinkage of not more than 20% when exposed to a temperature of 90° C. for 10 seconds.

2. The multilayer film according to claim 1 which shows shrinkage of at least 10% when exposed to a temperature of at least 110° C.

3. The multilayer film according to claim 1, wherein the film is oriented in a draw ratio of at least 1:3.

4. The multilayer film according to claim 1, wherein the polyolefin comprises one or more of high density polyethylene, linear low density polyethylene, low density polyethylene, very low density polyethylene, ultralow density polyethylene, and metallocene low density polyethylene.

5. The multilayer film according to claim 1, comprising at least three layers.

6. The multilayer film according to claim 1, comprising an inner core layer comprising polyethylene, and two surface layers comprising an ionomer, wherein the inner layer comprises from 60 to 95 weight % of the total film and the ionomer surface layers each independently comprise about 2 to about 20 weight % of the film.

7. The multilayer film according to claim 1, comprising an inner core layer of ionomer and two surface layers comprising polyethylene, wherein the inner core layer comprises from about 5 to about 40 weight % of the total film, and wherein each surface layer independently comprises from about 20 to about 50 weight % of the total film.

8. The multilayer film according to claim 1, having an A/B/C/B/A structure wherein the A skin layers comprise polyethylene, the B inner layers consist essentially of the ionomer, and the C core layers comprise polyethylene.

9. The multilayer film according to claim 5, wherein the core layer is thicker than the other layers.

10. A method for collation shrink wrapping an object comprising a plurality of individual product containers or at least one irregularly shaped object, and optionally a tray or pallet, comprising:
(i) obtaining a collation shrink film according to claim 1;
(ii) wrapping the object in the collation shrink film;
(iii) heating the object wrapped in the film in order to collation shrink the collation shrink film around the object to provide a collated product.

11. The method of claim 10 wherein the collation shrink film of (i) is supplied on a roll and (ii) comprises dispensing the collation shrink film from the spool and cutting the film into an appropriate length to wrap around the object.

12. The method of claim 10, wherein the collation shrink film is heat sealed to itself to wrap around the object.

13. (canceled)

14. A collated product comprising the film according to claim 1, wrapped around an object and optionally a tray or pallet, and shrunk to conform around the object.

15. The collated product of claim 14, wherein the object comprises a plurality of individual product containers, or wherein the object comprises at least one irregularly shaped object.

16. The collated product of claim 15, wherein the individual product containers comprise bottles, cans, jars, boxes, buckets, tubs, bags, or barrels; or wherein the at least one irregularly shaped object is machinery or furniture; or wherein the multilayer film structure is in the form of a generally planar film or sheet, a bag, a pouch, a hood, a sheath, a tube, a sleeve, or a lidding material.

17. The multilayer film according to claim 6, wherein the inner core layer comprises a blend of LDPE and HDPE; a blend of LDPE and LLDPE; or a blend of LDPE, HDPE and LLDPE.

18. The multilayer film according to claim 7, wherein the two surface layers comprise a blend comprising LDPE and LLDPE.

19. The multilayer film according to claim 8, wherein the at least one A layer comprises LLDPE, LDPE, or a blend of LLDPE and LDPE; and wherein the C core layers comprise a blend comprising LDPE and HDPE, a blend comprising LDPE and LLDPE, or a blend comprising LDPE, HDPE and LLDPE.

20. The multilayer film according to claim 19, wherein the at least one A layer comprises a blend comprising 70 to 95 weight % of LLDPE and 5 to 30 weight % of LDPE.

21. The multilayer film according to claim 19, wherein the C core layers comprise a blend comprising 5 to 30 weight % of LLDPE and 70 to 95 weight % of LDPE; a blend comprising 70 to 90 weight % of LDPE and 10 to 30 weight % of HDPE; or a blend comprising 30 to 80 weight % of LLDPE, 10 to 50 weight % of LDPE and 10 to 30 weight % of HDPE.
